(19) United States
(12) Patent Application Publication
(10) Pub. No.: US 2005/0177721 A1
(43) Pub. Date: Aug. 11, 2005

(54) File management system used in a peer-to-peer file-share mechanism

(75) Inventors: I-Ta Wu, Taipei (TW); Yi-Lin Wu, Taipei (TW); Shih-Jong Su, Taipei (TW); Kuo-Lung Chang, Taipei (TW)

Correspondence Address: BRUCE H. TROXELL, SUITE 1404, 5205 LEESBURG PIKE, FALLS CHURCH, VA, 22041, US

(73) Assignee: I-Ta WU

(21) Appl. No.: 10/880,551

(22) Filed: Jul. 1, 2004

(30) Foreign Application Priority Data
Feb. 10, 2004 (TW) 93201868

(51) Int. Cl. H04L 9/00

(52) U.S. Cl. 713/165

(57) ABSTRACT

A file management system is used in a peer-to-peer file-share mechanism. The file management system is used for managing at least one file transmitted between at least one data terminal and at least one abstracting terminal via networking. The data terminal stores the file and a searching data corresponding to the file. The searching data comprises a characteristic data of the file and a location of the file. After the characteristic data is chosen at the abstracting terminal, the abstracting terminal traces the location via networking, couples to the data terminal, and further abstracts the file corresponding to the characteristic data. The data terminal uses an encryption module to encrypt the file to an encryption file. A software package is used for conveniently transmitting the file to the abstracting terminal. Thus, the software package can decrypt the encryption file to the file for a user subsequently to use at the abstracting terminal.

### FIELD OF THE INVENTION

The present invention relates to a file management system, and more particularly to the file management system used in a restrained peer-to-peer file-share mechanism.

### BACKGROUND OF THE INVENTION

Referring to FIG. 1, a diagram about the public peer-to-peer file-share mechanism 2 in the art is shown. The typical peer-to-peer file-share mechanism 2 is used for transmitting digital content, e.g. images, video data, animation data, and audio data, via network 4 between a plurality of terminals 6 (personal computers) by a peer-to-peer transmitting method. Thus, the users of these terminals 6 can share these digital content.

As shown, a mediation server 8 is introduced to couple multiple terminals 6. The terminal 6 can further include a data terminal 6a for storing the digital content and an abstracting terminal 6b for the user to abstract the digital content from the respective data terminal 6a. The digital content comprises a file and a searching data corresponding to the file. The searching data comprises further a characteristic data and a location of the file. For example, the file may be music data or movie data, etc. The characteristic data is related to a file name like the title of the music. The location means the URL address of the data terminal 6a within the file and the file route in the data terminal 6a.

In fact, the peer-to-peer transmitting method involves only the data terminal 6a and abstracting terminal 6b. On the other hands, a mediation server 8 can increase the transmitting convenience. The searching data can be posited in the mediation server 8 so that the abstracting terminal 6b can abstract these searching data from the mediation server 8 and thus can easily browse these searching data.

After the searching data transmitted from the data terminal 6a to the mediation server 8 via a network 4, the abstracting terminal 6b can then abstract the searching data from the mediation server 8 also via networking. The user at the abstracting terminal 6b chooses the characteristic data of the searching data. The abstracting terminal 6b subsequently traces the location corresponding the characteristic data via the network 4 and thereafter couples to the respective data terminal 6a. Subsequently, the abstracting terminal 6b can abstract the file corresponding to the characteristic data from the data terminal 6a to the abstracting terminal 6b.

For example, the data terminal 6b can store various data of songs to the mediation server 8, in which the titles of these songs can be used to name the corresponding URL address of data terminal 6a. The abstracting terminal 6b downloads the searching data including the titles of these songs and the URL address of data terminal 6a from the mediation server 8, and also can use a browser to browse these titles of songs. When a user chooses a song title in the abstracting terminal 6b, the abstracting terminal 6b will abstract the data of song corresponding the title chosen by the user from the data terminal 6a. Subsequently, the user at the abstracting terminal 6b can enjoy the song.

FIG. 2 shows a diagram about the more widely public peer-to-peer file-share mechanism 2a in the art. In the networking, it may exist multiple mediation servers, e.g. mediation servers 8a, 8b as shown. Each mediation server 8a or 8b individually couples to respective multiple terminals 6, and can store searching data transmitted from these data terminals 6a who are further coupled directly or indirectly to the mediation servers 8a, 8b. In the example of FIG. 2, the data terminal 6a is coupled to the mediation server 8a while the abstracting terminal 6b is coupled to the mediation server 8b Upon such an arrangement, the searching data will be posited on the mediation server 8a, and so the abstracting terminal 6b can obtain the searching data through the mediation server 8b networked to the mediation server 8a.

FIG. 3 shows a diagram about an authority manager 10 in the art. For instance, in the case that a business wants to earn money in a public peer-to-peer file-share mechanism 2, then it should set an authority manager 10 at the mediation server 8. The authority manager 10 can authorize a user to transmit the file from a data terminal 6a to an abstracting terminal 6b when the user executes a behavior called right-getting condition, such as a payment, so that the user can be permitted to download, transmit or enjoy the digital content during an allowable period.

When the right-getting condition matches a predetermined condition set by the business, the authority manager 10 can issue a set of login account and password to the business.

However, the right or authority mentioned above can only allow the business to earn money through the public peer-to-peer file-share mechanism 2, but not provide protection upon the right or copyright of the owner. Definitely, this may cause serious problems to the business.

Therefore, the object of this invention is targeted to provide a restrained peer-to-peer file-share mechanism in solving the problem mentioned above.

### SUMMARY OF THE INVENTION

It is an object of the invention to provide a file management system used in a restrained peer-to-peer file-share mechanism for managing digital content with copyright transmitted through the networking.

This invention relates a file management system used for managing digital content with copyright transmitted through the networking. The management system comprises at least one data terminal, at least one abstracting terminal, an encryption module, an erasing module, and a copyright manager. The digital content comprises a file and a searching data as mentioned above. Wherein, these data terminals and abstracting terminals can couple each other via the network.

The data terminal stores the file and a searching data corresponding to the file. The searching data comprises a characteristic data of the file and a location of the file. The characteristic data may be a file name or a unique full data characteristic code. The location of the file comprises a URL address of the data terminal and a file route in the data terminal.

The abstracting terminal abstracts the searching data from the data terminal via the network, and the searching data can be further sent through the mediation server. By choosing the searching data at the abstracting terminal, the abstracting terminal can trace the location of the file via the network, couple to the data terminal, and abstract the file corresponding to the characteristic data.

The encryption module encrypts the file in the abstracting terminal to form an encryption file. After the encryption module generating the encryption file, the erasing module is used to erase the file in the abstracting terminal.

The copyright manager is used for comparing a right-getting condition generated by a user to a predetermined condition. The copyright manager will give the decrypting data to the user when the right-getting condition matches with the predetermined condition. The copyright manager is used for providing a decrypting data for decrypting the encryption file to the file for a user to subsequently use at the abstracting terminal.

The file management system further comprises an authority limits detector. The authority limits detector is used to determine whether the right-getting condition matches the predetermined condition or not while the user using the file at the abstracting terminal. If the right-getting condition does not match with the predetermined condition, the authority limits detector will restrain the abstracting terminal to use the encryption file. Further, the user can't use the file at the abstracting terminal.

In the present invention, the file management system can comprise a software package, and the software package can further comprise a displayer, a data-share module, and the authority limits detector. The data-share module comprises a browser and the encryption module. After abstracting the data-share module, the abstracting terminal browses the characteristic data of the searching data for following determination of the characteristic data at the abstracting terminal. Besides, the abstracting terminal uses the displayer to display the file decrypted form the encryption file by the copyright manager.

Therefore, by providing the file management system in the restrained peer-to-peer file-share mechanism of the present invention, it is convenience to manage and transmit digital content with copyright through the networking. Further, the file management system of the present invention cannot only protect the business in earning money, but can also protect the copyright of the owner.

### BRIEF DESCRIPTION OF THE APPENDED DRAWINGS

The advantages and spirits of the invention may be understood by the following recitations together with the appended drawing.

FIG. 1 shows a diagram of a conventional public peer-to-peer file-share mechanism.

FIG. 2 shows a diagram of another conventional public peer-to-peer file-share mechanism.

FIG. 3 shows a diagram of a typical authority manager in the art.

FIG. 4 shows a diagram of a preferred restrained peer-to-peer file-share mechanism in according with the present invention.

FIG. 5 shows a diagram of a preferrd software package in accordance with the present invention.

FIG. 6 shows a diagram of a preferred noticing module in according with the present invention.

FIG. 7 shows a flow chart of a preferred operating procedure of the file management system in according with the present invention.

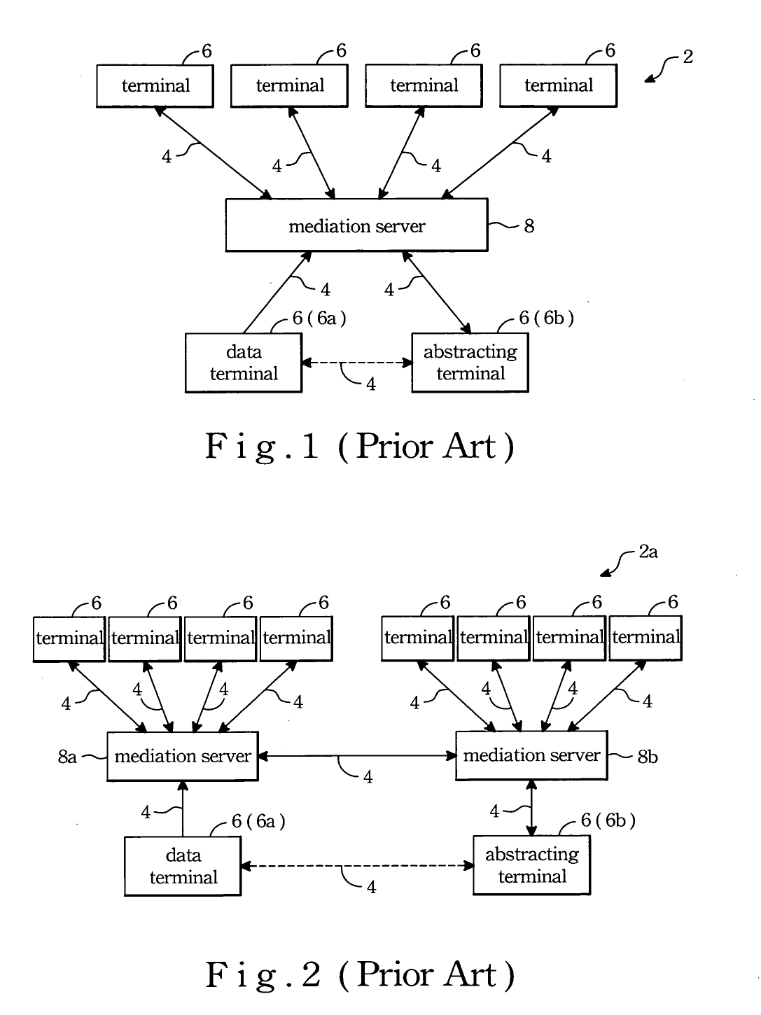

### DETAILED DESCRIPTION OF THE INVENTION

Referring to FIG. 4, a diagram of a preferred embodiment of a restrained peer-to-peer file-share mechanism 31 in according with the present invention is shown. This embodiment includes a file management system 30 for managing and transmitting digital content via the network 32. The digital content may be a file having various mp3 files, mpeg files, cda files, asf files, mid files, wma files, avi files, wmv files, wav files, asx files, aac files, and so on.

In the preferred embodiment of FIG. 4, the restrained peer-to-peer file-share mechanism 31 comprises at least one data terminal 34, at least one abstracting terminal 38, a mediation server 36, a software package 41, and a copyright manager 42. In the present invention, the mediation server 36 is not a required element and can be replaced in functions by the data terminal 34. Yet, for better describing this invention, the preferred embodiment here uses the mediation server 36 as a network knot for positing searching data.

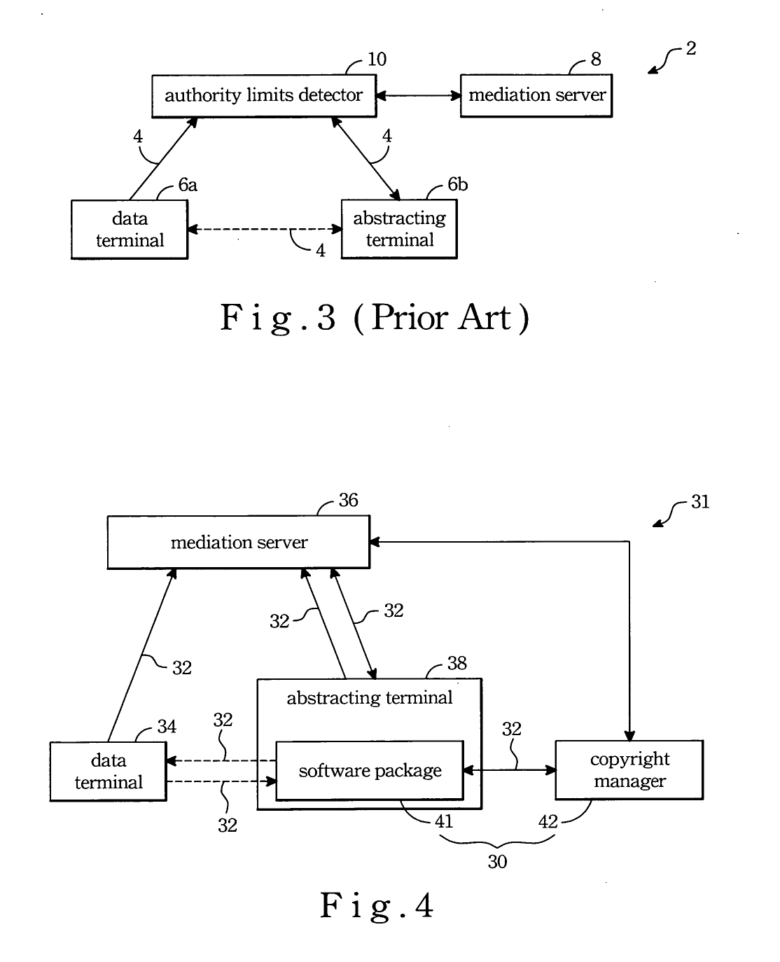

In the embodiment, the data terminal 34 or the abstracting terminal 38 may be a personal computer. The software package 41 can comprise a displayer, a data-share module, and the authority limits detector of FIG. 3. The software package 41 is used for being conveniently transmitted to the abstracting terminal 38. The software package 41 and the copyright manager 42 are included in the file management system 30.

The data terminal 34 is used for storing digital content. The digital content comprises a file and a searching data corresponding to the file. The searching data comprises a characteristic data of the file and a location of the file. The characteristic data may be a file name, or a unique full data characteristic code. The location of the file comprises a URL address of the data terminal and a file route in the data terminal.

In the present invention, the characteristic data can exist in various file types, such as file names, MD5 code, SHA code, or any the like. For the characteristic data can only occupy smaller memory capacity, so it can be transmitted easily through networking.

The mediation server 36 couples the data terminals 34 and the abstracting terminals 34 through networking. The searching data is transmitted from the data terminal 34 to the mediation server 36 via network 32.

In the present invention, the peer-to-peer transmitting method can only include the data terminal 34 and abstracting terminal 38. On the other hands, the mediation server 36 can increase the convenience for transmitting. The searching data can be posited on the mediation server 36 for the abstracting terminal 38 to abstract the searching data from the mediation server 36 and then browsing the characteristic data of the searching data. Thus, it will be operated more conveniently than previous design that is directly operating between the data terminal 34 and the abstracting terminal 38.

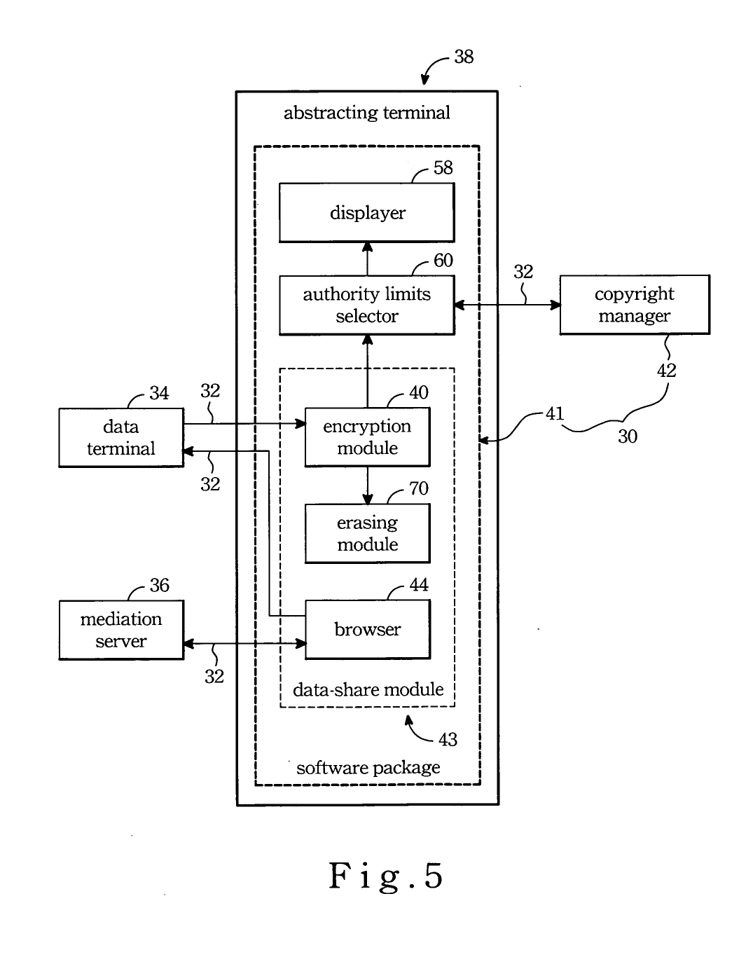

Referring to the FIG. 5 (also FIG. 4 for reference), it shows a diagram of the software package 41 in accordance with the present invention. In this illustration, the abstracting terminal 38 gets a software package 41 in advance. The software package 41 can be obtained from an optical disc or a floppy disc, or can be obtained through the network 32. The software package 41 comprises a displayer 58, a data-share module 43, an erasing module 70, and an authority limits detector 60.

The displayer 58, the data-share module 43, the erasing module 70, and the authority limits detector 60 are composed into the same software package 41 for being conveniently transmitted as a whole to the abstracting terminal 38 through networking at the same time. However, in the case that the authority limits detector 60 finds any mis-match between the right-getting condition and the predetermined condition, the abstracting terminal 38 will be forbidden to use the file.

The data-share module 43 comprises a browser 44 and the encryption module 40. After the abstracting terminal 38 abstracting the data-share module 43, then the abstracting terminal 38 abstracts searching data from the mediation server 36 via the network 32, and the abstracting terminal 38 browses the characteristic data within the searching data by using the browser 44 for subsequently choosing the characteristic data of the searching data at the abstracting terminal 38. For the characteristic data linking the location of the file, so after the user chooses the characteristic data at the abstracting terminal 38, the abstracting terminal 38 can abstract the file corresponding to the characteristic data from the data terminal 34 via the network 32, and subsequently encrypt to an encryption file by the encryption module 40. The displayer 58 of the data-share module 43 will then display the file decrypted form the encryption file by the copyright manager 42.

Furtherin the present invention, the abstracting terminals 38, the mediation server 36, and the data terminals 34 couple each other through networking. The abstracting terminal 38 abstracts the searching data from the mediation server 36, and browses the characteristic data of the searching data by using the browser 44. After a user chooses a characteristic data at the abstracting terminal 38, e.g. choosing a title of a song, the abstracting terminal 38 links to the file corresponding the location of the searching data at the data terminal 34, and then downloads the file from the data terminal 34 via the network 32.

The encryption module 40 in the abstracting terminal 38 encrypts the file to an encryption file while the abstracting terminal 38 abstracts the file. The erasing module 70 erases the file at the abstracting terminal after the encryption module 40 generates the encryption file. Subsequently, the copyright manager 42 can generate a private key for decrypting the encryption file to the file. Then, the authority limits detector 60 detects and restrains the abstracting terminal 38 who is using the file.

After the copyright manager 42 decrypting the encryption file to the file, the displayer 58 of the abstracting terminal 38 displays the file, video-ly or audio-ly, for the user to enjoy it.

The copyright manager 42 is used for providing a decrypting data for decrypting the encryption file into the file. Further, the copyright manager 42 is used for comparing a right-getting condition generated from a user with a predetermined condition. If the right-getting condition fits in with the predetermined condition, the copyright manager 42 will issue the decrypting data to the user at the abstracting terminal 38.

The authority limits detector 60 in the software package 41 is used for subsequently detecting if the right-getting condition matches with the predetermined condition or not. In the case that the right-getting condition does not match with the predetermined condition while the user using the file at the abstracting terminal 38, the authority limits detector 60 will restrain the user to use the decrypting data to further decrypt the encryption file into the file. The authority limits detector 60 can directly forbid the user to use the decrypting data, or can notice the user to reset the right-getting condition.

As mentioned above, the displayer 58 can be integrated with the authority limits detector 60 in the same software package 41. When the authority limits detector 60 restrains the user to use the decrypting data at the abstracting terminal 38, it also simultaneously restrains the displayer 58 to display the file. Thereby, the file management system 30 can monitor the usage of the file with copyright.

The predetermined condition can be set and stored in the copyright manager 42 by an operator of the file management system 30, or can be set by the copyright owner. The copyright owner can set the predetermined condition from a far-end terminal/server in advance or set directly at the file management system 30.

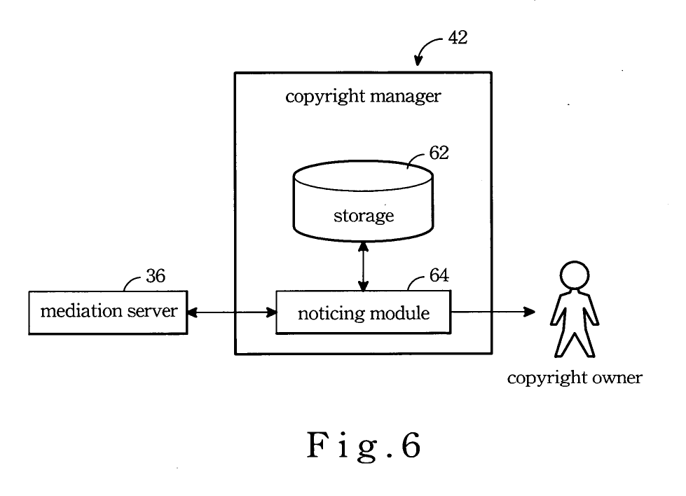

If the predetermined condition is set by an operator of the file management system 30, it may mean that the file is not authorized by the copyright owner yet. At this moment, the noticing module 64 can notice the copyright owner to reset the predetermined condition in the copyright manager 42. Referring to the FIG. 6, a diagram of the noticing module 64 in according with the present invention is shown. The copyright manager 42 comprises a storage 62 and a noticing module 64.

The storage 62 is used for storing the characteristic data and the copyright owner's name corresponding the characteristic data.

The noticing module 64 is used for comparing the characteristic data in the searching data abstracted from the mediation server 36 with the characteristic data stored in the storage 62. When the characteristic data in the searching data matches with the characteristic data stored in the storage 62, the noticing module 64 can notice the copyright owner to reset the predetermined condition in the copyright manager 42. The predetermined condition can relate to the fee that the user must pay for using the file, or to the benefit ratio that the business and the copyright owner can share individually.

The copyright owner can also set the predetermined condition from a far-end server in advance. The server can couples to the copyright manager 42 via networking. The authority limits detector 60 can compare the right-getting condition to the predetermined condition at the copyright manager 42 or at the far-end server through networking.

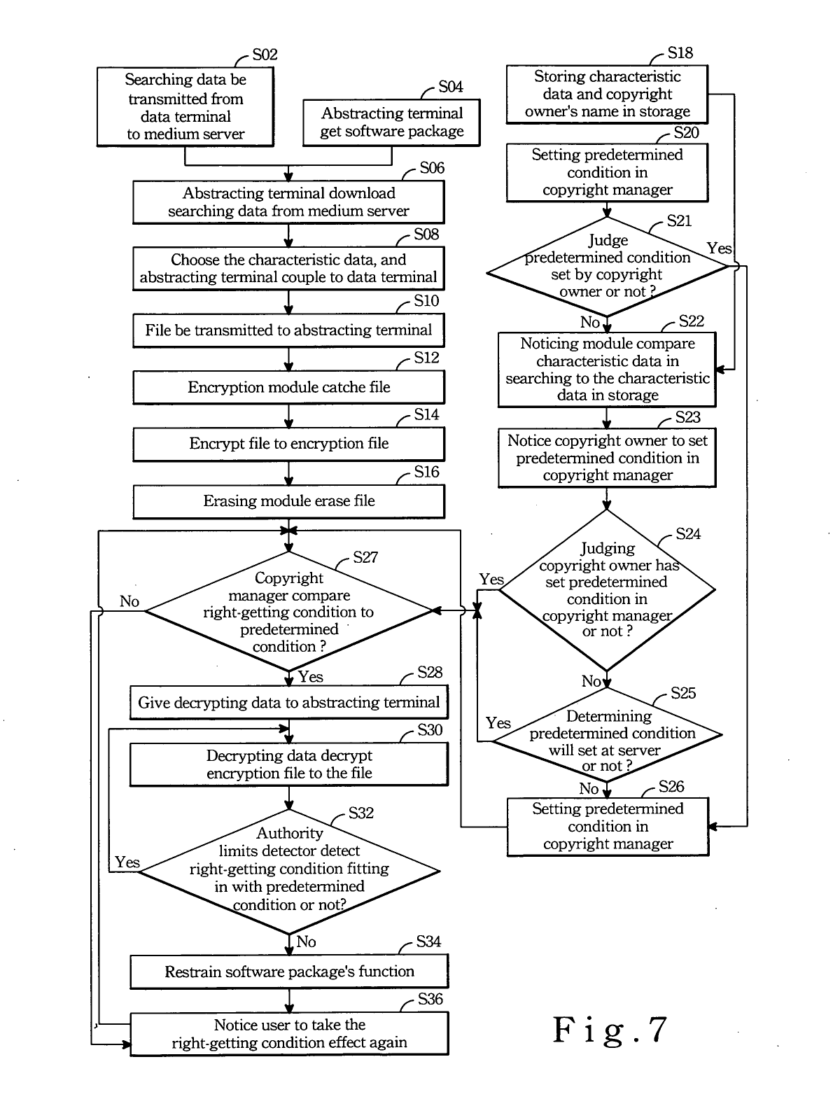

Referring to the FIG. 7, a flow chart of a preferred operating procedure of the file management system 30 in according with the present invention is shown. The method of the file management comprises following steps:

Step S02: The searching data corresponding to the file is transmitted from the data terminal 34 to the mediation server 36 via the network 32. The searching data comprises a characteristic data and the location of the file. The characteristic data may be a file name, or a unique full data characteristic code. The location of the file comprises a URL address of the data terminal 34 and a file route in the data terminal 34.

Step S04: The abstracting terminal 38 obtains a software package from an optical disc, or a floppy disc, or can be downloaded via networking. The software package comprises a displayer 58, a data-share module 43, and an authority limits detector 60. The data terminal 34 or the abstracting terminal 38 may be a personal computer. The data-share module 43 comprises a browser 44 and an encryption module 40.

Step S06: The abstracting terminal 38 downloads the searching data from the mediation server 36 via the network 32, and then browses the characteristic data of the searching data by the browser 44.

Step S08: After the user chooses the characteristic data, the abstracting terminal 38 couples to the data terminal 34 by the location of the file corresponding to the characteristic data.

Step S10: The file corresponding to the characteristic data is then transmitted from the data terminal 34 to the abstracting terminal 38 via the network 32.

Step S12: After the abstracting terminal 38 abstracts the file, the encryption module 40 catches the file at the abstracting terminal 38.

Step S14: The encryption module 40 encrypts the file into an encryption file.

Step S16: After the encryption module 40 encrypting the file into an encryption file, the erasing module 70 erases the file in the abstracting terminal 38.

Step S18: The characteristic data and the copyright owner's name corresponding to the characteristic data in the storage 62 are stored in advance.

Step S20: Subsequently, the predetermined condition in the copyright manager 42 is set by the operator of the file management system 30 or by the copyright owner.

Step S21: Determine if the predetermined condition is set by the copyright owner in the copyright manager 42. If positive, go to step 26. Otherwise, go to step 22.

Step S22: The noticing module 64 compares the characteristic data in the searching data from the mediation server 36 to the characteristic data stored in the storage 62.

Step S23: If the characteristic data in the searching data matches with the characteristic data stored in the storage 62, the noticing module 64 notices the copyright owner corresponding to the characteristic data stored in the storage 62 to set the predetermined condition in the copyright manager 42.

Step S24: Determine if the copyright owner has set the predetermined condition in the copyright manager 42 or not. If positive, go to step 27. If negative, go to step 25.

Step S25: Determine if the predetermined condition is set at the server of the copyright owner.

Step S26: The file management system 30 sets the predetermined condition by itself.

Step S27: The copyright-manager 42 couples to the server of the copyright owner to compare the predetermined condition. After the predetermined condition is formed, the copyright manager 42 compares the right-getting condition to the predetermined condition.

Step S28: As soon as the right-getting condition matches with the predetermined condition, the copyright manager 42 gives the decrypting data to the user at the abstracting terminal 38.

Step S30: The decrypting data is used for decrypting the encryption file to the file for a user to play the file by the displayer 58 at the abstracting terminal 38.

Step S32: The authority limits detector 60 monitors continuously if the right-getting condition still matches with the predetermined condition. If any mis-match in between appears, go to step 34. Otherwise, go back to step 30.

Step S34: The authority limits detector 60 restrains the function of the software package, and further restrains the displayer 58 to display the file.

Step S36: The authority limits detector 60 notices the user at the abstracting terminal 38 to reset the right-getting condition for a permission to use the decrypting data continuously.

Therefore, by providing the file management system 30 in the restrained peer-to-peer file-share mechanism 31 in accordance with the present invention, it is convenient to manage and transmit digital content with copyright protection through networking. Thus, the original digital content with copyright can be restricted to be spread. The file management system 30 of the present invention can not only protect the business to earn money, but can also protect the copyright owner. Definitely, it is obvious that the present invention is beneficial to the digital content industry.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A file management system used in a peer-to-peer file-share mechanism for managing at least one file transmitted between at least one data terminal and at least one abstracting terminal via networking, the data terminal storing the file and a searching data corresponding to the file, the searching data comprising a characteristic data of the file and a location of the file, the file management system comprising:
an encryption module for encrypting the file to an encryption file after the searching data is chosen, the abstracting terminal has traced the location via networking and further couples to the data terminal, and the file corresponding to the characteristic data has been abstracted;
an erasing module for erasing the file at the abstracting terminal after the encryption module generates the encryption file; and
a copyright manager for providing a decrypting data, the decrypting data used for decrypting the encryption file to the file for a user subsequently to use in the abstracting terminal.

2. The file management system according to claim 1, wherein the file management system further comprises:
a mediation server, coupling the data terminal and the abstracting terminal via networking, the data terminal coupling also to the abstracting terminal, the data terminal transmitting the searching data to the mediation server; the abstracting terminal abstracting the searching data from the mediation server after the characteristic data is chosen within the searching data, then the abstracting terminal abstracting the file corresponding to the searching data via the location of the file from the data terminal.

3. The file management system according to claim 1, wherein the characteristic data is selected from the group consisting of a file name, and a unique full data characteristic code.

4. The file management system according to claim 1, wherein the location of the file comprises a URL address of the data terminal, and a file route in the data terminal.

5. The file management system according to claim 1, the file management system further comprising a data-share module, the data-share module comprising a browser and the encryption module, the abstracting terminal browsing the characteristic data within the searching data by using the browser for subsequently choosing the searching data in the abstracting terminal.

6. The file management system according to claim 2, wherein the copyright manager is used for comparing a right-getting condition generated from the user with a predetermined condition, the copyright manager giving the decrypting data to the user when the right-getting condition matches with the predetermined condition.

7. The file management system according to claim 6, the file management system further comprising an authority limits detector for determining if the right-getting condition matches with the predetermined condition, the authority limits detector restraining the abstracting terminal to use the encryption file when the right-getting condition does not match with the predetermined condition.

8. The file management system according to claim 7, wherein the abstracting terminal further comprises a displayer for displaying the file decrypted form the encryption file by the copyright manager.

9. The file management system according to claim 8, the file management system further comprising a software package, the software package comprising the displayer, the data-share module, and the authority limits detector.

10. The file management system according to claim 6, wherein the predetermined condition is set in the copyright manager by a copyright owner in advance.

11. The file management system according to claim 10, wherein the copyright manager further comprises:
a storage for storing the characteristic data and the copyright owner corresponding to the characteristic data; and
a noticing module for noticing the copyright owner corresponding to the characteristic data stored in the storage to set the predetermined condition in the copyright manager after the characteristic data abstracted from the data terminal is compared to the characteristic data stored in the storage.
